(19) United States
(12) Patent Application Publication
(10) Pub. No.: US 2026/0328385 A1
(43) Pub. Date: Oct. 22, 2026

(54) SWIRL INDUCED COMBUSTION IN CIRCULATING FLUIDIZED BED SYSTEMS

(71) Applicant: METSO METALS OY, Espoo (FI)

(72) Inventors: Robert MADUTA, Hemsbach (DE); Edgar GASAFI, Karlsruhe (DE)

(73) Assignee: METSO METALS OY, Espoo (FI)

(21) Appl. No.: 19/109,841

(22) PCT Filed: Sep. 8, 2022
(86) PCT No.: PCT/FI2022/050599

§ 371 Date: Mar. 7, 2025

(51) Int. Cl. F23C 10/02; F23C 10/20; F23C 10/22

(52) U.S. Cl. CPC F23C 10/02; F23C 10/20; F23C 10/22

(57) ABSTRACT

A circulating fluidized bed (CFB) furnace for heating and calcination of a material is disclosed. A process for heating and/or calcination of a material is further disclosed.

### TECHNICAL FIELD

The present disclosure relates to a circulating fluidized bed (CFB) furnace for heating and calcination of a material. The present disclosure further relates to a process for heating and/or calcination of a material.

### BACKGROUND

Calcination refers to thermal treatment of a solid chemical compound (e.g. ores) whereby the compound is raised to high temperature without melting under restricted supply of ambient oxygen (i. e. gaseous O₂ fraction of air), generally for the purpose of removing impurities or volatile substances and/or to incur thermal decomposition. Calcination can be performed in essentially any type of equipment or reactor where the temperature can be raised to a sufficient level, such as a fluidized bed furnace or a circulating fluidized bed furnace (CFB).

In fluidized bed combustion (FBC), fuel particles are suspended in a hot, bubbling fluidity bed of ash and other particulate materials (sand, limestone, ore etc.) through which jets of air are blown to provide the oxygen required for combustion or gasification. The resultant fast and intimate mixing of gas and solids promotes rapid heat transfer and chemical reactions within the bed. FBC plants are capable of burning a variety of low-grade solid fuels, including most types of coal, coal waste and woody biomass, at high efficiency and without the necessity for expensive fuel preparation (e.g., pulverising), as well as liquid or gaseous fuels. In addition, for any given thermal duty, FBCs are smaller than the equivalent conventional furnace, so may offer significant advantages over the latter in terms of cost and flexibility.

A circulating fluidized bed (CFB) is a type of Fluidized bed combustion that utilizes a recirculating loop for even greater efficiency of combustion, while achieving lower emission of pollutants.

A CFB is a perfectly mixed reactor, which refers to the solids bed, however, it has deficiencies for the gas/gas mixing in the freeboard area. Especially when most of the combustion air is introduced as secondary combustion air, a proper mixing of fuel and air is beneficial for the combustion process.

There is a risk, that the fuel is directed quickly towards the top of the furnace and there to it rising to the top only in streaks. Depending on the injection velocity the fuel jet affects the flow pattern only a short distance from the furnace wall. The center of the furnace will not be affected. At the same time, the center is largely affected by highly penetrating jets of secondary combustion air.

The rising fuel streaks (located close to the CFB walls) will create a relatively small contact zone to the rising secondary air jets (located in the center). This means that there is not sufficient contact (time and space) of fuel with combustion air. This has a negative impact on CO and NOx emissions, which result from incomplete combustion.

If mixing is not sufficient then there will be only mass exchange by molecular diffusion, supported by bubble eruption from the solids bed at the bottom of reactor.

Deficiency of mixing will lead to insufficient mixing of fuel and air and ultimately to incomplete combustion.

### SUMMARY

A circulating fluidized bed (CFB) furnace for heating and calcination of a material is disclosed. The CFB furnace may comprise injection ports for combustion fuel and secondary combustion air that are arranged to induce swirling in the furnace.

A process for heating and/or calcination of a material is further disclosed. The process may comprise that the injection ports for combustion fuel and secondary combustion air are arranged to induce swirling in the furnace.

### BRIEF DESCRIPTION OF THE DRAWINGS

The accompanying drawing, which is included to provide a further understanding of the embodiments and constitute a part of this specification, illustrates various embodiments. In the drawings:

FIGS. 1-10 present various arrangements of nozzles for combustion fuel and secondary combustion air.

FIG. 11 present a side view of the arrangement of nozzles for combustion fuel and secondary combustion air.

FIGS. 12 and 13 present the flow of combustion fuel and secondary combustion air in a circulating fludized bed furnace.

### DETAILED DESCRIPTION

A circulating fluidized bed (CFB) furnace for heating and/or calcination of a material is disclosed. The CFB furnace may comprise injection ports for combustion fuel (1) and secondary combustion air (2) are arranged to induce swirling in the furnace.

In certain embodiments, the injection ports for combustion fuel (1) are arranged directly below the injection ports for secondary combustion air (2).

In certain embodiments, the combustion fuel may be any combustible gas such as natural gas, syngas, biogas, or any mixture thereof. In certain embodiments, the second fuel may be any suitable gaseous combustible hydrocarbon, such as methane, ethane, propane, butane, acetylene, ethene, propene, propyne, or any mixture thereof. In one embodiment, the second fuel is selected from the group consisting of methane, ethane, propane, butane, acetylene, ethene, propene, propyne, or any mixture thereof.

In certain embodiments, the injection ports for combustion fuel and primary combustion air are arranged in the lower part of the furnace where the volume fraction of particles is high. As is known to a person skilled in the art, solid material is fed into the bottom part of a CFB furnace, where it is fluidized by feeding primary combustion air into the furnace through a grate or nozzles located at the bottom of the furnace. As a consequence of this, a CFB furnace will, when it is in operation, comprise a bed of higher volume fraction of particle in the bottom part, while the flow of combustion air and other gases will cause particles to fly up into the higher parts of the furnace, leading to the volume fraction of particles decreasing as the distance from the bottom of the furnace increases.

In certain embodiments, combustion air is injected on one or more levels in the furnace from several injection nozzles as secondary air in addition to primary air which is injected from the bottom via the nozzle grate.

In certain embodiments, the combustion air may be preheated prior to injection into the CFB furnace.

In certain embodiments, preheated combustion air is injected on one or more levels in the furnace from several injection nozzles as secondary air in addition to primary air which is injected from the bottom via the nozzle grate.

In certain embodiments, the fuel is fed into the bottom part of the furnace, at a height β of max 1.5 m above the floor/nozzle grate, or lower than 1.2 m and or lower than 0.9 m above the floor.

In the present disclosure, the height β is measured from the level of the floor or nozzle grate of the CFB furnace.

In certain embodiments, secondary combustion air ports are located on a higher level, where the volume fraction of particles is lower.

In certain embodiments, secondary air is injected into the furnace on one or more levels in the furnace from several injection nozzles.

In certain embodiments, the nozzle/lance exit velocity of the fuel injected into the furnace is below 150 m/s or below 100 m/s. In certain embodiments, the nozzle/lance exit velocity of the fuel injected into the furnace is above 10 m/s.

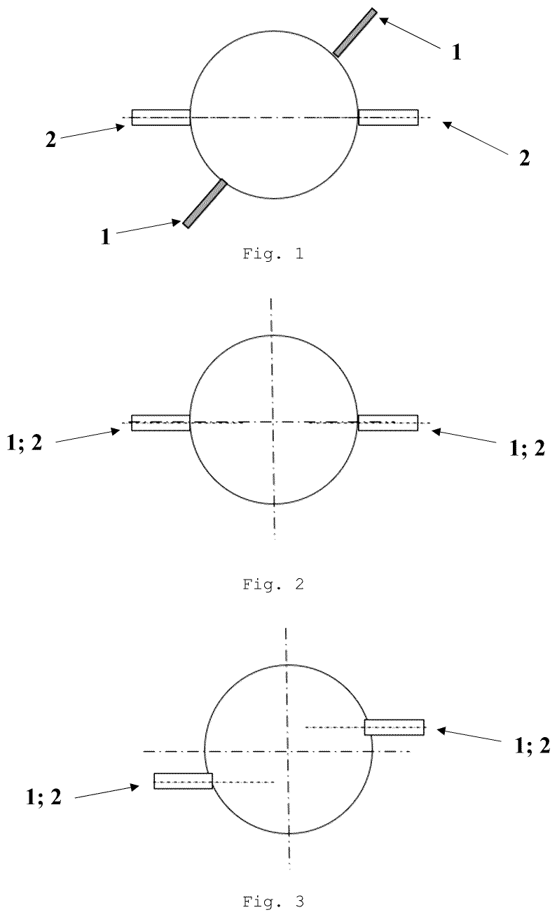

FIGS. 1 and 2 present previously known arrangements for feeding fuel and secondary combustion air into a CFB furnace which do not induce swirling in the furnace. In FIG. 1, the ports for fuel (1) and secondary combustion air (2) do not overlap, meaning that they are fed into the furnace essentially independently and do not induce controlled swirl in the furnace. In FIG. 2, the ports for fuel (1) and secondary combustion air (2) are arranged at the center of the furnace, causing them not to induce controlled swirl in the furnace.

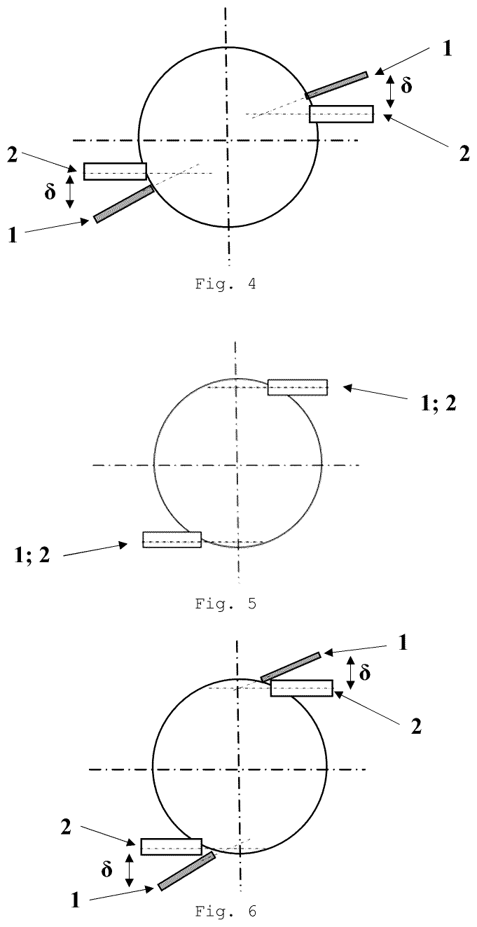

Various embodiments of a CFB furnace according to the present disclosure are described in FIG. 3 to 10. All of FIGS. 3 to 10 show a top view of a CFB furnace according to the present specification.

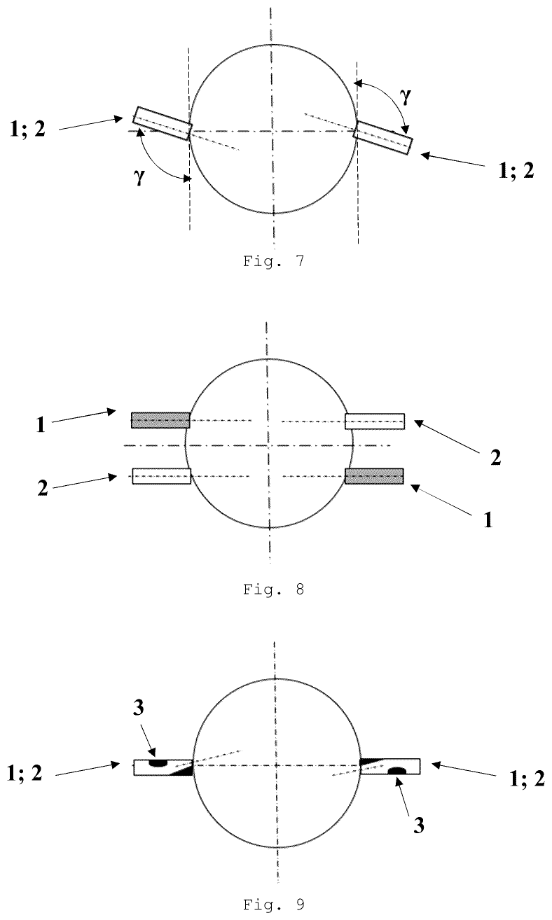

In FIGS. 3 and 5, the injection ports for combustion fuel (1) are arranged directly below the injection ports for secondary combustion air (2) and off-center with respect to the CFB furnace, thereby causing swirl inside the furnace.

In certain embodiments, the injection ports for fuel (1) are arranged at an angle σ of −5 to +30° relative to the injection ports for combustion air (2) as illustrated in FIGS. 4 and 6. As use herein and in FIG. 4, the negative direction of the angle is defined as the injection ports for fuel (1) being angled toward the center of the furnace compared to the injection ports for air. As use herein and in FIG. 4, the positive direction of the angle is defined as the injection ports for fuel (1) being angled toward the perimeter of the furnace, away from the center, compared to the injection ports for air.

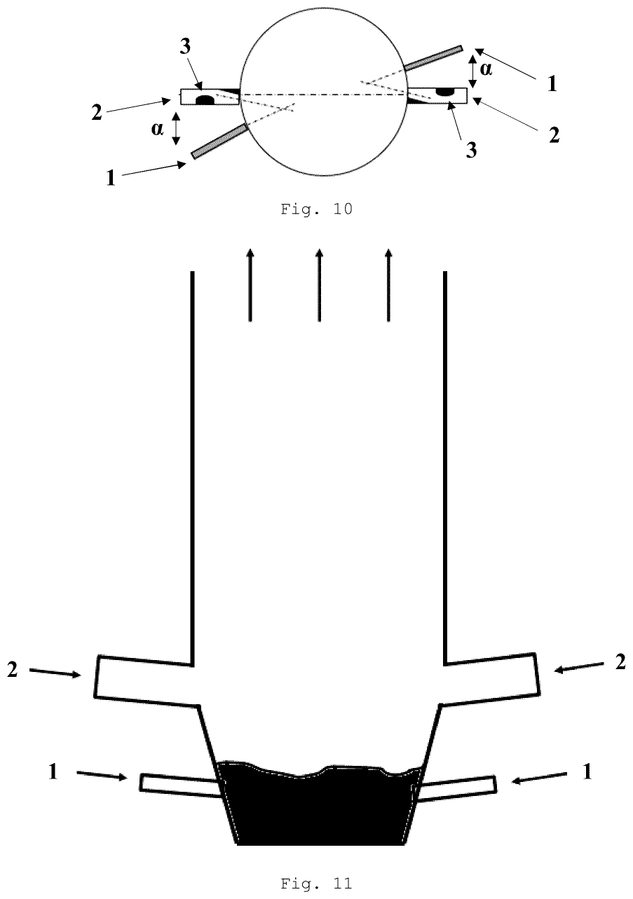

As shown in FIG. 7, the injection ports for combustion fuel (1) are arranged directly below the injection ports for secondary combustion air (2) at an angle γ relative to a level on the furnace wall that is parallel to the horizontal center line of the furnace, thereby causing swirl inside the furnace.

In certain embodiments, the injection ports are arranged at an angle γ of 90°+/−45°, or 90°+/−35°, or 90°+/−20° relative to a level on the furnace wall that is parallel to the horizontal center line of the furnace.

In certain embodiments, the injection ports are arranged upwards or downwards at an angle of 90°+/−45°, or 90°+/−35°, or 90°+/−20° relative to the vertical axis of the furnace.

In FIG. 8, the injection ports for combustion fuel (1) are arranged below the injection ports for secondary combustion air (2) in positions where they are not directly above each other. If both sets of injection ports are arranged off-center with respect to the center line of the CFB furnace, they will induce swirling in the furnace.

In certain embodiments, air guides or fins (3) may be retrofitted in the injection ports of existing CFB furnaces to induce swirling in the furnace.

FIGS. 9 and 10 present embodiments of a CFB furnace according to the present disclosure, where air guides have been retrofitted in injection ports to alter the direction of the gases fed into the CFB furnace, thereby introducing swirling.

In certain embodiments, the injection ports are arranged at an angle α of 0 to 30° relative to each other as illustrated in FIG. 10.

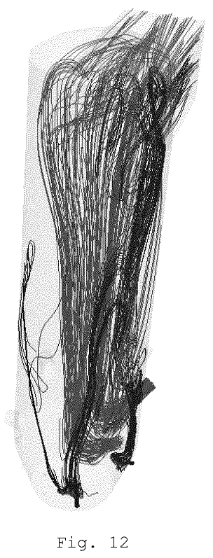

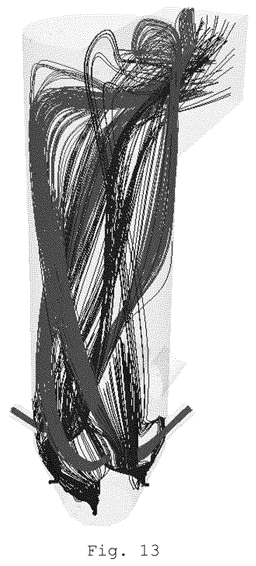

FIGS. 12 and 13 further illustrate the effect of inducing swirl on the flow of gases in a CFB furnace. FIG. 12 presents a conventional arrangement, where the fuel and secondary combustion air are fed into the CFB furnace without inducing swirling. FIG. 13 illustrates a situation where the feeding of the gases into the CFB furnace introduces swirling in the furnace during operation. In FIG. 12, both gases flow nearly directly to the top of the furnace and exit there, whereas in FIG. 13, the swirling increases the distance traveled within the furnace and therefore also the residence time of the gases and the particles carried by the gases.

In certain embodiments, the processed material is a mixture of aluminium trihydroxide and calcined aluminium oxide (i.e. alumina). In certain embodiments, the processed material is alumina.

As shown in FIG. 11, the injection ports for combustion fuel (1) are arranged directly below the injection ports for secondary combustion air (2).

A process for the calcination of a material is disclosed. The process may comprise that the injection ports for combustion fuel and secondary combustion air are arranged to induce swirling in the furnace.

In certain embodiments, the injection ports for combustion fuel (1) are arranged directly below the injection ports for secondary combustion air (2).

In certain embodiments, the combustion fuel may be any combustible gas such as natural gas, syngas, biogas, or any mixture thereof. In certain embodiments, the second fuel may be any suitable gaseous combustible hydrocarbon, such as methane, ethane, propane, butane, acetylene, ethene, propene, propyne, or any mixture thereof. In one embodiment, the second fuel is selected from the group consisting of methane, ethane, propane, butane, acetylene, ethene, propene, propyne, or any mixture thereof.

In certain embodiments, the injection ports for combustion fuel and primary combustion air are arranged in the lower part of the furnace where the volume fraction of particles is high.

In certain embodiments, combustion air is injected on one or more levels in the furnace from several injection nozzles as secondary air in addition to primary air which is injected from the bottom via the nozzle grate.

In certain embodiments, the fuel is fed into the bottom part of the furnace, at a height β of max 1.5 m above the floor/nozzle grate, or lower than 1.2 m, or lower than 0.9 m above the floor.

In the present disclosure, the height β is measured from the level of the floor or nozzle grate of the CFB furnace.

In certain embodiments, secondary combustion air ports are located on a higher level, where the volume fraction of particles is lower.

In certain embodiments, secondary air is injected into the furnace on one or more levels in the furnace from several injection nozzles.

In certain embodiments, the nozzle/lance exit velocity of the fuel injected into the furnace is below 150 m/s or below 100 m/s. In certain embodiments, the nozzle/lance exit velocity of the fuel injected into the furnace is above 10 m/s.

In certain embodiments, the injection ports are arranged at an angle α of 0 to 30° relative to each other as illustrated in FIG. 10.

In certain embodiments, the injection ports are arranged at an angle γ of 90°+/−45°, or 90°+/−35°, or 90°+/−20° relative to a level on the furnace wall that is parallel to the horizontal center line of the furnace.

In certain embodiments, the injection ports are arranged upwards or downwards at an angle of 90°+/−45°, or 90°+/−35°, or 90°+/−20° relative to the vertical axis of the furnace.

In certain embodiments, the injection ports for fuel (1) are arranged at an angle α of −5 to +30° relative to the injection ports for combustion air (2) as illustrated in FIGS. 4 and 6. As use herein and in FIG. 4, the negative direction of the angle is defined as the injection ports for fuel (1) being angled toward the center of the furnace compared to the injection ports for air. As use herein and in FIG. 4, the positive direction of the angle is defined as the injection ports for fuel (1) being angled toward the perimeter of the furnace, away from the center, compared to the injection ports for air.

In certain embodiments, air guides or fins (3) may be retrofitted in the injection ports of existing CFB furnaces to induce swirling in the furnace.

In certain embodiments, the processed material is a mixture of aluminium trihydroxide and calcined aluminium oxide (i.e. alumina). In certain embodiments, the processed material is alumina.

The circulating fluidized bed (CFB) furnace for heating and/or calcination of a material described in the current specification has the added utility of providing a method for calcining a material with improved mixing of fuel and secondary combustion air, leading to reduced emissions of CO and NOx due to more complete combustion of the fuel. Introducing swirling in the CFB furnace additionally increases the flow path which increases the contact time between air and gaseous fuel. Additionally, a CFB furnace according to the present invention enables improved mixing of fuel and secondary combustion air, leading to reduced emissions of CO and NOx due to more complete combustion of the fuel.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A circulating fluidized bed (CFB) furnace or a process, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A circulating fluidized bed (CFB) furnace for heating and calcination of a material, wherein the injection ports for combustion fuel and secondary combustion air are arranged to induce swirling in the furnace.

2. The CFB furnace according to claim 1, wherein the injection ports for combustion fuel are arranged directly below the injection ports for secondary combustion air.

3. The CFB furnace according to claim 1, wherein the injection ports for combustion fuel and primary combustion air are arranged in the lower part of the furnace where the volume fraction of particles is high.

4. The CFB furnace according to claim 1, wherein secondary air is injected into the furnace on one or more levels in the furnace from several injection nozzles.

5. The CFB furnace according to claim 1, wherein the nozzle/lance exit velocity of the fuel injected into the furnace is below 150 m/s or below 100 m/s.

6. The CFB furnace according to claim 1, wherein the injection ports are arranged at an angle α of 0 to 30° relative to each other.

7. The CFB furnace according to claim 1, wherein the injection ports are arranged at an angle γ of 90°+/−45°, or 90°+/−35°, or 90°+/−20° relative to a level on the furnace wall that is parallel to the horizontal center line of the furnace.

8. The CFB furnace according to claim 1, wherein the processed material is a mixture of aluminium trihydroxide and calcined aluminium oxide.

9. A process for heating and/or calcination of a material, wherein the injection ports for combustion fuel and secondary combustion air are arranged to induce swirling in the furnace.
